(19) United States
(12) Patent Application Publication
(10) Pub. No.: US 2019/0078017 A1
(43) Pub. Date: Mar. 14, 2019

(54) SHELL AND CORE STRUCTURES FOR COLLOIDAL SEMICONDUCTOR NANOCRYSTALS

(71) Applicant: Lumisyn LLC, Rochester, NY (US)

(72) Inventor: Keith Kahen, Rochester, NY (US)

(73) Assignee: Lumisyn LLC, Rochester, NY (US)

(21) Appl. No.: 16/131,874

(22) Filed: Sep. 14, 2018

Related U.S. Application Data
(60) Provisional application No. 62/558,391, filed on Sep. 14, 2017.

(51) Int. Cl. C09K 11/88

(52) U.S. Cl. CPC C09K 11/885; B82Y 20/00

(57) ABSTRACT

Nanocrystals including a III-V class semiconductor core and a II-VI class semiconductor shell that at least partially coats the core, in which the shell includes a magnesium-containing first zone and a magnesium-free buffer zone provided between the core and the first zone. Nanocrystals including a non-homogeneous inner core having a first non-uniform band energy profile, and a non-homogeneous outer core having a second non-uniform band energy profile.

### CROSS-REFERENCE TO RELATED APPLICATIONS

This application claims priority to U.S. Provisional Patent Application Ser. No. 62/558,391 filed Sep. 14, 2017, which is incorporated by reference herein in its entirety.

### STATEMENT REGARDING FEDERALLY SPONSORED RESEARCH

This disclosure was made, at least in part, with support from the Department of Energy under Grant No. DE-SC0013249. The government may have certain rights in the invention.

### TECHNICAL FIELD

The present disclosure relates to shelled colloidal semiconductor nanocrystals having improved emissive and stability properties.

### BACKGROUND

Colloidal semiconductor nanocrystals have many potential uses, for example, as phosphors for solid state lighting and gain material for optically-pumped cw (continuous wave) lasers. For these applications, the operating temperature of the nanocrystals is significantly above room temperature and the optical excitation power density can range from about 100 (in solid state lighting) to greater than 50,000 (for lasing) W/cm2. Typical CdSe-based nanocrystals lose significant quantum efficiency under such conditions. Some improvements have been made, e.g., as described in U.S. Pat. No. 9,153,731, but further improvements are needed.

Most colloidal semiconductor nanocrystals are sensitive to the ambient environment, e.g., to oxygen and water vapor present in air. Such nanocrystals need to be encased or encapsulated in materials having low oxygen or water permeability. This adds cost to devices using nanocrystals. The encapsulating material may also fail over time. Further improvements are needed to improve the stability of high efficiency nanocrystals exposed to air.

### SUMMARY

There remains a need for nanocrystals that have high temperature and flux stability, high quantum efficiency and improved air stability.

In accordance with an embodiment of this disclosure, a nanocrystal is provided that includes a semiconductor core and a II-VI class semiconductor shell that at least partially coats the core, the shell having a magnesium-containing first zone and a magnesium-free buffer zone provided between the core and the first zone.

In accordance with another embodiment of this disclosure, a nanocrystal is provided that includes a semiconductor core and a II-VI class semiconductor shell that at least partially coats the core, the shell including a magnesium-containing first zone proximal to the core and a second zone distal from the core, the second zone having less magnesium than the first zone.

In accordance with another embodiment of this disclosure, a nanocrystal is provided that includes a semiconductor core and a II-VI class semiconductor shell that at least partially coats the core, the shell including a magnesium-containing first zone proximal to the core, a magnesium-free buffer zone provided between the core and the first zone, and a second zone distal from the core, the second zone having less magnesium than the first zone.

In accordance with another embodiment of this disclosure, a nanocrystal is provided having a ternary or quaternary III-V class semiconductor core and a II-VI class semiconductor shell that at least partially coats the core, the shell including ZnMgSe, ZnMgS, ZnMgSeS, CdMgSe, CdMgS or CdMgSeS.

In accordance with another embodiment of this disclosure, a colloidal semiconductor nanocrystal is provided that includes a non-homogeneous inner core having a first non-uniform band energy profile and a non-homogeneous outer core having a second non-uniform band energy profile. The non-homogeneous outer core at least partially coats the non-homogeneous inner core, and the second non-uniform band energy profile comprises a peak level higher than any peak level of the first non-uniform band energy profile.

In another embodiment of the present disclosure, a method of making semiconductor nanocrystals is provided. The semiconductor nanocrystals have a non-homogeneous distribution of different first and second elements selected from a common group of the periodic table. The method includes: a) heating to a first temperature a reaction solution having at least one solvent; b) combining the heated reaction solution contemporaneously with a first precursor solution including a first element and a second precursor solution including a second element, wherein the first precursor solution and the second precursor solution react at different rates; c) forming a suspension of intermediate nanocrystals having a non-homogeneous distribution of the first and the second elements; and d) after completing step c), adding to the suspension of intermediate nanocrystals a solution including a third precursor material comprising a third element to form a suspension of nanocrystals having a non-homogeneous outer core having a non-homogeneous distribution of the first, the second and the third elements that differs from a distribution in a non-homogeneous inner core.

The present disclosure provides colloidal semiconductor nanocrystals that may have one or more of the following advantages: high quantum efficiency; significantly improved photoluminescence efficiency at elevated temperatures; significantly improved photoluminescence efficiency under high excitation optical flux densities; and improved photoluminescence stability in the presence of air (oxygen) and moisture. In certain embodiments, these performance advantages may be achieved without the need for toxic elements such as arsenic and cadmium.

### BRIEF DESCRIPTION OF THE DRAWINGS

The following detailed description of specific embodiments of the present disclosure can be best understood when read in conjunction with the following drawings, in which:

FIG. 1 a cross-sectional view of a colloidal semiconductor nanocrystal according to certain embodiments of the present disclosure;

FIG. 2 a cross-sectional view of a colloidal semiconductor nanocrystal according to certain embodiments of the present disclosure;

FIG. 3A is a graph showing the nanocrystal's relative band energy as a function of position along the nanocrystal radius according to various embodiments of the present disclosure;

FIG. 3B is a graph showing the nanocrystal's relative band energy as a function of position along the nanocrystal radius according to various embodiments of the present disclosure

FIG. 3C is a graph showing the nanocrystal's relative band energy as a function of position along the nanocrystal radius according to various embodiments of the present disclosure

FIG. 3D is a graph showing the nanocrystal's relative band energy as a function of position along the nanocrystal radius according to various embodiments of the present disclosure;

FIG. 4 a cross-sectional view of a colloidal semiconductor nanocrystal further including a shell according to an embodiment of the present disclosure;

FIG. 5 is a graph showing the photoluminescent intensity in arbitrary units as a function of time for an embodiment of the nanocrystals of the present disclosure.

FIG. 6 is an absorbance spectrum of non-homogeneous InGaP nanocrystals of Example 3 of the present disclosure;

FIG. 7 is an HRTEM image of the shelled nanocrystal of Example 3 of the present disclosure;

FIG. 8 is a graph depicting the relative photoluminescent intensity over a range of temperatures for certain nanocrystals of the present disclosure and conventional nanocrystals;

FIG. 9 is a graph of photoluminescent intensity in arbitrary units for embodiments of the nanocrystals of the present disclosure as a function of excitation power density and temperature;

FIG. 10 is a graph of photoluminescent intensity in arbitrary units for embodiments of the nanocrystals of the present disclosure as a function of excitation power density at 167° C., and

FIG. 11 is a graph of photoluminescent intensity in arbitrary units for embodiments of the nanocrystals of the present disclosure as a function of excitation power density at 25° C.

### DETAILED DESCRIPTION

As used throughout this disclosure, “electrons and holes” may refer to “excitons” and/or unbound electrons and holes. Reference to Group II, III, IV, V and VI elements is made following the Chemical Abstracts Services (CAS) naming protocol of the periodic table of elements. Unless otherwise specified, Group II herein refers to both IIA and IIB (Group Numbers 2 and 12 of the modern IUPAC system), Group III refers specifically to IIIA (Group Number 13 of the modern IUPAC system), Group IV refers specifically to IVA (Group Number 14 of the modern IUPAC system), Group V refers specifically to VA (Group Number 15 of the modern IUPAC system) and Group VI refers specifically to VIA (Group Number 16 of the modern IUPAC system).

As used throughout this disclosure, the nanocrystals may be referred to as “colloidal” meaning that they form a colloidal solution in which the nanocrystals do not settle at the bottom of the solution, but remain in a generally suspended state, in which the nanocrystals are at least partially dispersed in the solution. In contrast, conventional nanocrystals, such as those formed by classical semiconductor growth processes, (including molecular beam epitaxy (MBE) or metal-organic chemical vapor deposition (MOCVD)) are referred to as self-assembled quantum dots.

Without being bound by any particular theory, some embodiments of nanocrystals of the present disclosure may have high quantum efficiencies, not only at room temperature, but also at elevated temperatures, e.g., at 170° C. or even higher, and at very high optical flux densities, e.g., at 5 kW/cm2 or even higher. In some embodiments, nanocrystals of the present disclosure have improved stability in air. Given these properties, the nanocrystals may be used as advantaged phosphors in solid state lighting and LED applications to produce high quality light having higher efficiency than conventional nanocrystals. Moreover, optically-pumped devices containing nanocrystals of the present disclosure can also be formed. Some examples are optically-pumped cw-ASE (amplified spontaneous emission) devices and optically-pumped lasers. The cw-ASE device produces highly-polarized, spectrally-narrow, and spatially-coherent light. As an example, a cw-ASE device can be used to make advantaged LCD displays when employed as a backlight. The applications of an optically-pumped laser are myriad, including, for example, medical, biological, and semiconductor-based applications. In addition to their stable quantum efficiencies, the nanocrystals of the present disclosure are also highly desirable for their non-blinking characteristics in such applications as single photon emitters (for quantum computing) and for biological tracking.

Certain embodiments of the present disclosure provide colloidal semiconductor nanocrystals having a II-VI class semiconductor shell, at least a portion of which includes magnesium. Certain embodiments of the present disclosure provide colloidal, enhanced-confinement semiconductor nanocrystals having a non-homogeneous inner core, a non-homogeneous outer core, and, optionally, a shell. The term “enhanced-confinement” nanocrystal refers to the enhancement of the confinement of the electrons and holes to a center region of the nanocrystal, for which the radius of the region is much smaller than the exciton Bohr radius.

The prefix “nano” (such as nanocrystal) refers to a component having an average size, such as an average length, width, or diameter, of from 0.1 to 100 nm. The term “non-homogeneous” refers to a composition of parts or elements that are not substantially identical.

Embodiments of the present disclosure having a II-VI class semiconductor shell, at least a portion of which includes magnesium, shall be described first.

Some embodiments of colloidal semiconductor nanocrystals of this disclosure have magnesium-containing II-VI class semiconductor shells and a buffer layer (such as a low-magnesium or magnesium-free II-VI class semiconductor) disposed between a III-V class semiconductor core and a magnesium-containing zone in the shell. In some embodiments, the shell that includes the magnesium-free buffer zone and the magnesium-containing zone coating the core provides a very large increase in photoluminescent quantum efficiency, such that the photoluminescent quantum efficiency has an increased by a factor of 5. Other embodiments of this disclosure include a low-magnesium or magnesium-free II-VI class semiconductor outer shell over the magnesium-containing zone that dramatically improves stability under operational conditions (in the presence of oxygen and moisture). The combination of both results in nanocrystals having very high quantum efficiencies and air stability. The nanocrystals of the present disclosure may also provide high quantum efficiencies at elevated temperature and high optical flux densities.

Specific embodiments will now be described with reference to the figures. Whenever possible, the same reference numerals will be used throughout the drawings to refer to the same or like parts. As used throughout this disclosure, the singular forms “a,” “an” and “the” include plural referents unless the context clearly dictates otherwise. Thus, for example, reference to “a” component includes aspects having two or more such components, unless the context clearly indicates otherwise.

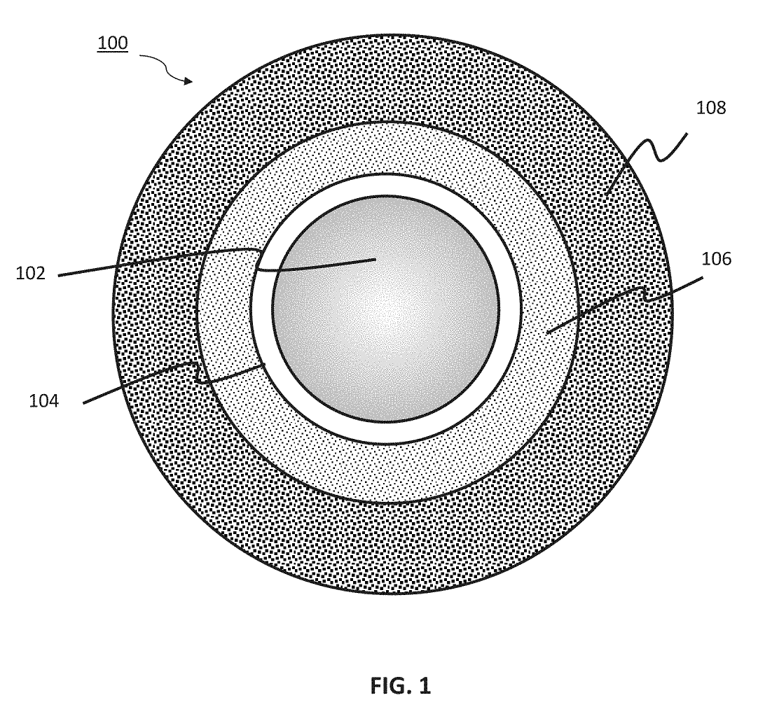

Some embodiments of the colloidal semiconductor nanocrystal of the present disclosure are schematically illustrated in FIG. 1. In FIG. 1, nanocrystal 100 has a semiconductor core 102. A II-VI class semiconductor shell is provided over the core, the shell including a magnesium-containing first zone 106 and a second zone 108 having less magnesium than the first zone. The shell further includes a buffer zone 104 disposed between the core and the first zone. In an embodiment, the nanocrystal may include second zone 108 but not buffer zone 104. In an embodiment, the nanocrystal may include buffer zone 104, but not second zone 108. While FIG. 1 depicts the nanocrystal as spherical, it is nonetheless intended that the colloidal nanocrystal is not necessarily spherical, but may be oblong, faceted or other shapes, such as those shapes common to colloidal nanocrystals. In some embodiments, the total shell thickness may be up to 100 monolayers. In some embodiments, the radius of the semiconductor core in the largest dimension is typically in a range of 1 nm to 10 nm, for example, in a range of 1 nm to 5 nm.

In some embodiments, semiconductor core 102 may include III-V class semiconductors, II-VI class semiconductors, IV class semiconductors, or IV-VI class semiconductors. Some non-limiting examples of semiconductor materials that may be used in the core, alone or in combination, may include InP, InGaP, InN, InPN, InPSb, InAlP, GaN, GaP, InAs, InSb, GaAs, GaSb, AlAs, AlSb, InAsSb, GaAsSb, AlAsSb, InAlP, InAlSb, InAlAs, CdSe, CdZnSe, ZnSe, CdTe, CdZnSTe, Ge, Si and GeSi. It will be appreciated by those skilled in the art that the preceding chemical formulae may not necessarily represent a particular stoichiometry, but rather, the formulae are intended to convey the presence of a particular set of materials. For example, one of ordinary skill in the art would understand that InGaP generally refers to any composition represented by InxGa(1-x)P, where subscript x is equal to or greater than zero and less than or equal to 1 (0<3x≤1). In various embodiments, x is greater than 0 and less than 1. In some embodiments, the elemental composition of the core may be homogeneous.

In some embodiments, the elemental composition of the core is non-homogeneous and varies along at least a portion of the core radius. In some embodiments, the core may include inner and outer regions having different elemental compositions or distributions of components, wherein one or both of the regions may have a non-homogeneous distribution of components. For the case of typical enhanced-confinement ternary III-V or II-VI class semiconductor nanocrystals, the diameter of the non-homogeneous inner core region may be less than 2.0 nm, such as from 0.5 to 1.5 nm, and the thickness of the outer core region may be in the range of about 0.5 to 4 nm, such as from about 0.75 to 2.0 nm.

As mentioned, the shell may be based on II-VI class semiconductor materials. The magnesium-containing first zone 106 of the shell includes at least some magnesium as one of the group II elements and may further include another group II element such as Zn, Be, Cd, Hg, or a combination thereof. The corresponding group VI element may, for example, be S, Se, Te or a combination thereof. The magnesium-containing first zone may be homogeneous or non-homogeneous with respect to chemical composition throughout the zone. In some embodiments, the magnesium-containing first zone may include ZnMgSe, ZnMgS, ZnMgSeS, CdMgSe, CdMgS, CdMgSeS or combinations thereof. As mentioned before, it will be appreciated by those skilled in the art that the preceding chemical formulae may not necessarily represent a particular stoichiometry, but rather, the formulae are intended to convey the presence of a particular set of materials. For example, one of ordinary skill in the art would understand that ZnMgSeS generally refers to any composition represented by ZnₓMg₍₁₋ₓ₎Se_{y}S_{(1-y)}, where subscript x is equal to or greater than zero and less than or equal to 1 (0≤x≤1) and subscript y is equal to or greater than zero and less than or equal to 1 (0≤y≤1). In various embodiments, x is greater than 0 and less than 1. In some embodiments, the ratio of magnesium to all other group II elements (e.g., Zn or Cd) in the magnesium-containing first zone may be in a range from about 4:1 to about 1:10, alternatively in range from about 3:1 to about 1:5. In some embodiments, the first zone is in a range of about 1 to 20, about 1 to 10, or 1 to 8 monolayers thick.

The composition of the shell's second zone is not limited and may include any suitable class of semiconductor, especially those which are more stable when exposed to air or moisture. In an embodiment, the second zone may include a III-V class semiconductor such as GaN or InN, but other III-V class materials may work. The shell's second zone may include a II-VI class semiconductor material. In some embodiments, the second zone may include magnesium as one of the group II elements, but if so, the atomic % of magnesium in the second zone is lower than the atomic % of magnesium in the magnesium-containing first zone. In some embodiments, the second zone is substantially free of magnesium. The phrase “substantially free of” refers to less than 10 atomic %. The group II element in the second zone may, for example, include Zn, Mg, Be, Cd, Hg, or a combination thereof. The corresponding group VI element in the second zone may include, for example, S, Se, Te or a combination thereof. The second zone may be homogeneous or non-homogeneous with respect to chemical composition throughout the zone. In some embodiments, the second zone may include ZnSe, ZnS or ZnSeS or combinations thereof. As mentioned previously, it will be appreciated by those skilled in the art that the preceding chemical formulae may not necessarily represent a particular stoichiometry, but rather, the formulae are intended to convey the presence of a particular set of materials. For example, one of ordinary skill in the art would understand that ZnSeS generally refers to any composition represented by ZnSe_{y}S_{(1-y)}, where subscript y is equal to or greater than zero and less than or equal to 1 (0 <y <1). In various embodiments, y is greater than 0 and less than 1. In some embodiments, the second zone is in a range of about 1 to 20 or about 4 to 20 monolayers thick.

In some embodiments, the shell may include a buffer zone that may include a II-VI class semiconductor material having a lower atomic % of magnesium than the first zone. In some embodiments, the buffer zone may be substantially free of magnesium. The group II element in the buffer zone may, for example, include Zn, Be, Cd, Hg, or a combination thereof. The corresponding group VI element in the buffer zone may, for example, be S, Se, Te or a combination thereof. The buffer zone may be homogeneous or non-homogeneous with respect to chemical composition throughout the zone. In some embodiments, the buffer zone may include

ZnSe, ZnS, ZnSeS, CdSe, CdS, CdSeS or combinations thereof. As mentioned previously, it will be appreciated by those skilled in the art that the preceding chemical formulae may not necessarily represent a particular stoichiometry, but rather, the formulae are intended to convey the presence of a particular set of materials. For example, one of ordinary skill in the art would understand that ZnSeS generally refers to any composition represented by ZnSe_{y}S_{(1-y)}, where y is equal to or greater than zero and less than or equal to 1 (0≤y≤1). In various embodiments, y is greater than 0 and less than 1. In some embodiments, the buffer zone is thinner than the first or second zones. In some embodiments, the buffer zone is in a range of about 1 to 4 monolayers thick. In some embodiments, the buffer zone may include a monolayer of ZnSe.

The colloidal semiconductor nanocrystals having the above-described first, second and buffer zones have an improved high-temperature and flux stability compared to prior art nanocrystals. Unexpectedly, when the second zone is added to the colloidal semiconductor nanocrystal, the colloidal semiconductor nanocrystal has an improved stability in air when compared to nanocrystals not having the second zone. The buffer zone significantly improves quantum efficiencies. In some embodiments, nanocrystals of the present disclosure may have improved high-temperature stability, flux stability, quantum efficiency and air stability.

Without being bound by any particular theory, an important feature of an embodiment of the present disclosure is the II-VI class semiconductor shell wherein at least a portion includes magnesium. Relative to, for example, ZnSeS, MgSeS has a larger band gap and one that is more equitably distributed between the valence and conduction band energy offsets relative to the core. The author has found that this combination may result in better exciton confinement and higher quantum efficiencies, including at elevated temperature and/or high optical flux conditions. However, growing a magnesium-containing shell directly on a III-V semiconductor core can be difficult. Such nanocrystals may have a higher tendency to form defects. These defects result in a loss of quantum efficiency. Unexpectedly, when a substantially magnesium-free buffer zone is disposed between the core and the magnesium-containing shell, as described previously, the magnesium-containing shells may then be grown successfully over III-V class semiconductor cores.

In some embodiments of the present disclosure, a nanocrystal may include a III-V class semiconductor core and a II-VI class semiconductor shell that at least partially coats the core. The shell may have a magnesium-containing first zone and a substantially magnesium-free buffer zone provided between the core and the first zone. The magnesium-containing first zone and the substantially magnesium free buffer zone have been described above. The phrase “at least partially coated” in reference to the semiconductor means that at least 50% of the core surface is coated by the shell. In some embodiments of the nanocrystal, the shell may coat the core from at least 70% to less than or equal to 100%. In one or more embodiments of the nanocrystal, the shell may coat the core from 50% to 100%. All subranges of “at least 50% to 100%” are included within the range.

In one or more embodiments, the semiconductor core 102 may include III-V semiconductor material. A non-limiting list of III-V semiconductor materials that may be used in the core, alone or in combination, may include InP, InGaP, InGaSbP, InSb, InAsP, InPSb, InAlP, GaN, and GaP. It will be appreciated by those skilled in the art that the preceding chemical formulae may not necessarily represent a particular stoichiometry, but rather, the formulae are intended to convey the presence of a particular set of materials. For example, one of ordinary skill in the art would understand that InGaP generally refers to any composition represented by InₓGa₍₁₋ₓ₎P, where subscript x is equal to or greater than zero and less than or equal to 1.0 (0≤x≤1). In various embodiments, x is greater than 0 and less than 1. In some embodiments, the elemental composition of the core may be homogeneous. In some embodiments, the elemental composition of the core is non-homogeneous and varies along at least a portion of the core radius. In some embodiments, the core may include inner and outer regions having different elemental compositions or distributions of components, wherein one or both regions may have a non-homogeneous distribution of components. For the case of typical enhanced-confinement ternary III-V class semiconductor nanocrystals, the diameter of the non-homogeneous inner core region may be less than 2.0 nm, such as from 0.5 to 1.5 nm, and the thickness of the outer core region may be in the range of about 0.5 to 4 nm, such as from about 0.75 to 2.0 nm.

Embodiments of the present disclosure providing colloidal, enhanced-confinement semiconductor nanocrystals having a non-homogeneous inner core, a non-homogeneous outer core, and optionally a shell, shall now be described. It should be noted that the non-homogeneous cores described below may optionally be used in combination with the magnesium-containing II-VI shell structures described above. However, the non-homogeneous cores may optionally be used with other shell structures.

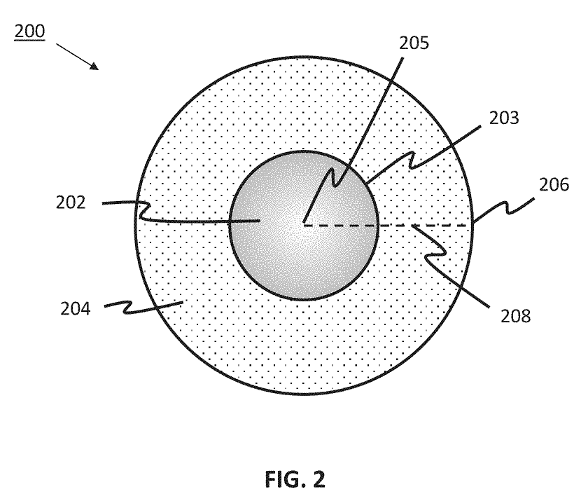

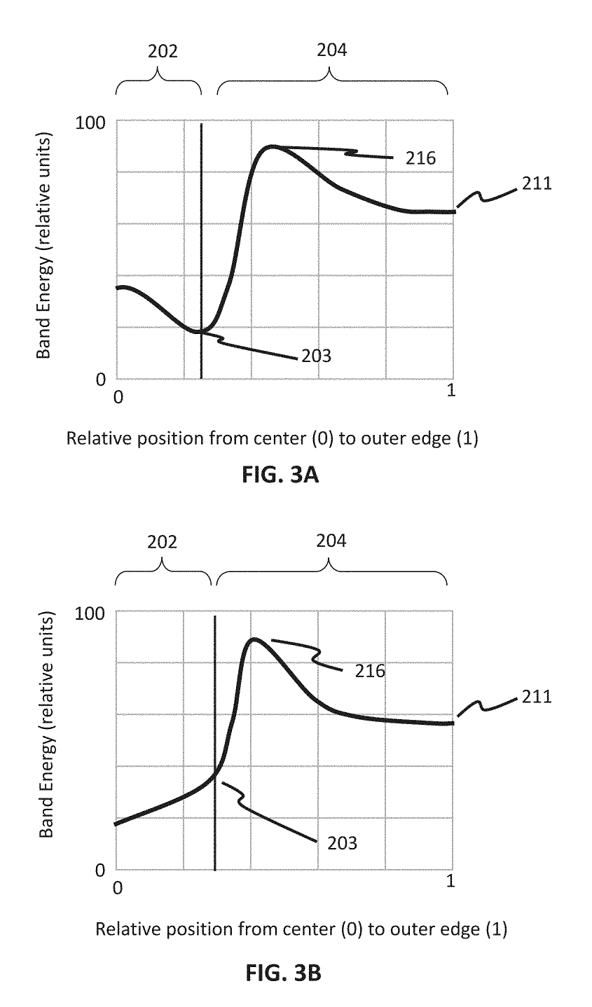

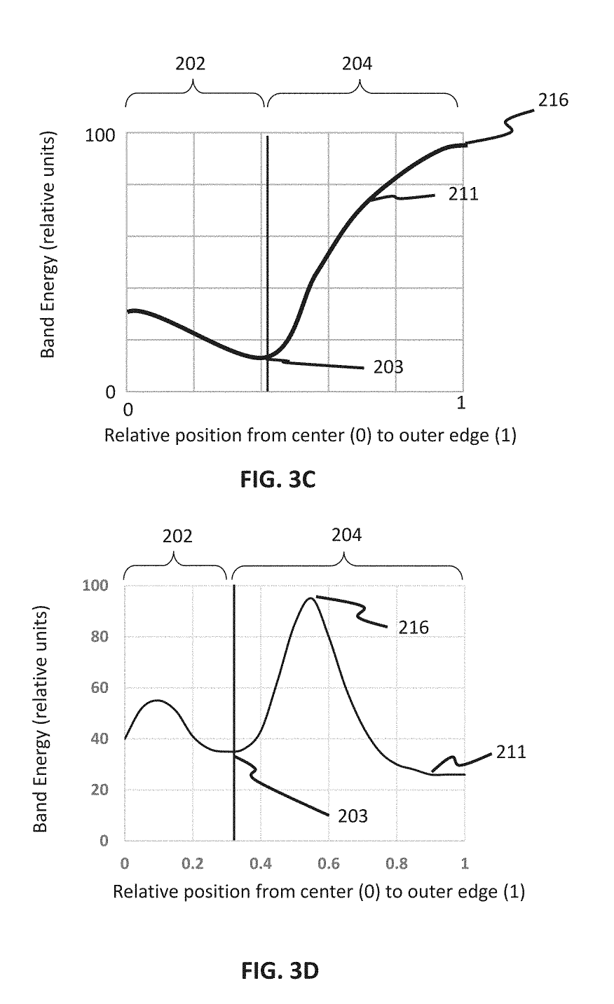

An embodiment of a colloidal semiconductor nanocrystal of the present disclosure is schematically illustrated in FIG. 2. In FIG. 2, the colloidal semiconductor nanocrystal 200 has a center point 205 and an outer edge 206 that define a radius 208. While FIG. 2 depicts the nanocrystal as spherical, it is nonetheless intended that the colloidal nanocrystal is not necessarily spherical, but may be oblong, faceted or other shapes, such as those shapes common to colloidal nanocrystals. The radius 208 in the largest dimension is typically in a range of 1 nm to 10 nm, for example, in a range of 1 nm to 5 nm. Colloidal semiconductor nanocrystal 200 includes a non-homogeneous inner core 202 and a non-homogeneous outer core 204, and a beginning 203 where the non-homogeneous outer core 204 begins. The non-homogeneous inner core 202 includes a first semiconductor material having a distribution of components that varies along the radius 208. As shown in FIGS. 3A-3D, this produces a first non-uniform band energy profile 211 within the inner core with respect to electrons, holes or both. While electron (conduction) band energy is often used herein to describe embodiments of the present disclosure, similar concepts apply to hole (valence) band energy or both hole and electron band energy. The non-homogeneous outer core 204 includes a second semiconductor material having a distribution of components that varies along the radius 208. This produces a second non-uniform band energy profile within the outer core having a peak level that is higher than any level of the first non-uniform band energy profile. The first and second non-uniform band energy profiles are selected so that the band energy profile from the center to the outer edge of the nanocrystal includes an increase in the band energy level forming an inflection point corresponding to the beginning of the non-homogeneous outer core. The band energy level increases from the inflection point to the peak level.

Some non-limiting examples of the first non-uniform band energy profile 211 along the nanocrystal radius are shown in each graph of FIGS. 3A-3D. The energy profile graphs apply to electron band energy, hole band energy or both. The first non-uniform band energy profile 211 can take many forms, but all have common features. First, the energy profile is not entirely flat (not uniform) within the non-homogeneous inner core 202 or within the non-homogeneous outer core 204. Second, the band energy profile from the center to the outer edge of the nanocrystal includes an increase in the band energy level forming an inflection point in the energy profile corresponding to the beginning 203 of the non-homogeneous outer core. Third, the band energy increases from the inflection point to a peak level 216 in the non-homogeneous outer core 204. This increase in the peak level might not be linear. Fourth, the peak level 216 is higher than any level found in the non-homogeneous inner core 202.

In an embodiment, the inflection point, i.e., the beginning 203 of the non-homogeneous outer core 204, might be dimensionally closer to the nanocrystal center than to its outer edge. The non-homogeneous inner core 202 might constitute about ⅛ to about ⅓ of the nanocrystal radius, such as about ⅛ to ¼. In some embodiments, such as in FIG. 3C, peak level 216 might occur at or near the outer edge of the colloidal semiconductor nanocrystal 200. In an embodiment, such as that shown in FIG. 3A, the peak level 216 might be away from the outer edge and the band energy decreases to a lower level at the outer edge. In an embodiment, peak level 216 may be at least 20% higher than the highest level within the non-homogeneous inner core 202. In an embodiment, peak level 216 might be closer to the beginning 203 of the non-homogeneous outer core 204 than to the outer edge 206.

A first non-uniform band energy profile 211 is set up by forming a non-homogeneous distribution of semiconductor materials. In an embodiment, the inner and outer core semiconductor materials might be the same semiconductor class. That is, the first and second semiconductor materials may be both type III-V semiconductors, or alternatively, they may be both type II-VI semiconductors. In some embodiments, they both may be type IV semiconductors, or may be type IV-VI semiconductors. In some embodiments, the inner core semiconductor material may be of a different class than the outer core semiconductor material. For example, the non-homogeneous inner core 202 may include a type IV semiconductor and the semiconductor material of the non-homogeneous outer core 204 may be a type II-VI semiconductor.

In some embodiments, the non-homogeneous inner core 202 of the colloidal semiconductor nanocrystal 200 may be formed of a first semiconductor material including a first set of at least two different elements selected from a common periodic table group. This first set of two different elements may have a non-homogeneous distribution along the nanocrystal radius. For example, the non-homogeneous inner core may be formed of a type III-V semiconductor and the first set of at least two different elements are selected from Group III of the periodic table such as In and Ga. Alternatively, or in addition, the two different elements may be selected from Group V of the periodic table, such as P and Sb. Materials that form a larger band gap generally increase the electron band energy. For example, GaP has a larger band gap than InP. When the nanocrystal includes a non-homogeneous ternary InGaP non-homogeneous inner core, variations in the Ga-to-In ratio along the radius are used to vary the electron band energy, as increasing Ga will cause an increase in the electron band energy. Similarly, the bandgap of InP is higher than InSb. When the nanocrystal includes a non-homogeneous ternary InPSb non-homogeneous inner core, variations in the P-to-Sb ratio along the radius are used to vary the electron band energy—increasing P will cause an increase in the electron band energy.

The non-uniform band energy distribution in the non-homogeneous outer core 204 may be controlled in a manner analogous to that described for the non-homogeneous inner core 202. The non-homogeneous outer core 204 may be formed of a second semiconductor material including a second set of at least two different elements selected from a common periodic table group. This second set of two different elements may have a non-homogeneous distribution along the nanocrystal radius. Materials that form a higher band gap can increase the electron band energy. This second set may be the same as the first set, but the distribution may be different in the non-homogeneous outer core 204 in order to form the inflection point and peak level in the band energy profile as previously discussed. Alternatively, the second set may include different materials. For example, the non-homogeneous inner core 202 may be a non-homogeneous InPSb (where the first set of two different elements are selected from Group V of the periodic table, i.e., P and Sb), and the non-homogeneous outer core 204 may be a non-homogeneous distribution of InGaP (where the second set of two different elements are selected from Group III of the periodic table, i.e., In and Ga).

Some non-limiting examples of semiconductor materials useful when forming non-homogeneous inner core 202 or non-homogeneous outer core 204 are shown in Table 1. In Table 1, element sets selected from a common group of the periodic table are bracketed. Elements that increase electron band energy when their elemental percentage increases are also listed (the same list applies for hole band energy). As mentioned, the non-homogeneous inner core 202 and non-homogeneous outer core 204 may be formed from the same type of semiconductor. The selection of elements may be the same or different, but the electron band energy profile may be different between the two. Methods to calculate electron or hole band energies are well known in the art.

TABLE 1
Examples of non-homogeneous inner or non-homogeneous outer cores

| | | Electron band energy |
|---|---|---|
| | | increased by increasing |
| Type of semiconductor | Elemental composition | elemental % of |
| III-V | [In Ga] P | Ga |
| III-V | [In Al] P | Al |
| III-V | In [P Sb] | P |
| III-V | In [P N] | N |
| III-V | [In Ga] [P Sb] | Ga and/or P |
| II-VI | [Cd Zn] Se | Zn |
| II-VI | Zn [Se S] | S |
| II-VI | [Cd Zn] Te | Zn |
| IV | [Ge Si] | Si |

For the case of typical enhanced-confinement CdZnSe and InGaP-based nanocrystals, the diameter of the non-homogeneous inner core 202 may be generally less than 2.0 nm, such as from 0.5 to 1.5 nm. Thus, for the case of typical CdZnSe- and InGaP-based nanocrystals, the electrons and holes are confined to a smaller volume than that for conventional colloidal semiconductor nanocrystals. For the case of typical CdZnSe- and InGaP-based nanocrystals, the thickness of the non-homogeneous outer core 204 may be in the range of about 0.5 to 4 nm, such as from about 0.75 to 2.0 nm. For the case of typical CdZnSe- and InGaP-based nanocrystals, the peak level 216 (the band energy maximum) may be within about 1 nm, such as within 0.5 nm, of the surface of the non-homogeneous inner core 202.

In an embodiment based on InGaP, the average Ga content of the non-homogeneous inner core 202 may be in a range of about 5 to 40%, while the average Ga content in the non-homogeneous outer core 204 may be in a range of about 20 to 60%. In this embodiment, the average Ga content of the non-homogeneous outer core 204 may be generally higher than the average Ga content of the non-homogeneous inner core 202.

For the case of an arbitrary semiconductor material with an exciton Bohr radius of Bᵣ, the diameter of the non-homogeneous inner core 202 may be less than about 0.2 Bᵣ, with a preferred range of about 0.05-0.15 Bᵣ. For the case of an arbitrary semiconductor material, the maximum in the band energy should be approximately within 0.1 Bᵣ, such as within about 0.05 Bᵣ, of the beginning 203 of the non-homogeneous outer core. In some embodiments, the electron band energy profile does not have discontinuities. For the case of an arbitrary semiconductor material, the thickness of the non-homogeneous outer core 204 should be in the range of about 0.05-0.4 Bᵣ, with a preferred range of about 0.075-0.2 Bᵣ. As discussed below, the nanocrystal may further be shelled.

Possible lattice structures of the enhanced-confinement nanocrystal and its optional shell(s) are well-known in the art and, for example, may include zincblende, wurtzite, or rocksalt structures. The optional shell structure and the enhanced-confinement nanocrystal typically have the same lattice structure; however, the nanocrystals of the present disclosure also include the case where the two lattice structures are different.

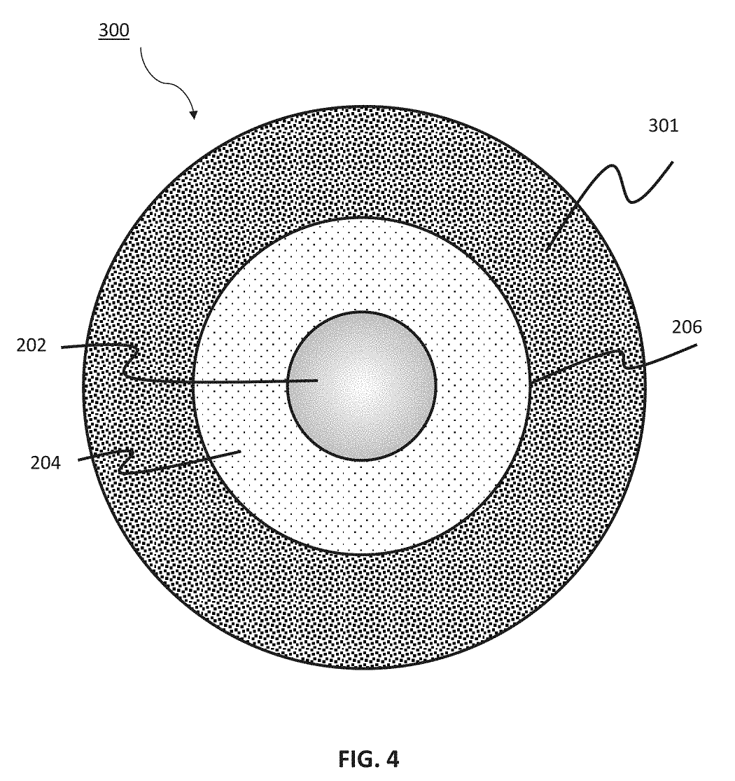

While shelling may be not required over the non-homogeneous cores of FIGS. 2-3, the quantum efficiency and environmental stability of the enhanced-confinement nanocrystals may be increased by shelling them with at least one layer of a material having a composition different from that of the inner or outer core. In an embodiment, colloidal semiconductor nanocrystal 200 of FIG. 2 may form semiconductor core 102 of FIG. 1. FIG. 4 shows a general embodiment of a shelled nanocrystal 300 having a shell 301 provided over the outer edge 206 of colloidal semiconductor nanocrystal 200 from FIG. 2 having a non-homogeneous inner core 202 and non-homogeneous outer core 204.

The material of shell 301 typically has a wider bandgap than that of the materials comprising the enhanced confinement nanocrystal. Either a single shell or multiple shells may be used to form shell 301. For example, the number of shells may range from 1 to 100 monolayers, including each integer in between. Each single shell or each multiple shell may include any wider bandgap semiconductor(s) that result in additional confinement of the enhanced confinement nanocrystal. Particular examples are type IV, II-VI, III-V, or IV-VI semiconductors, or combinations thereof.

In some embodiments, the colloidal semiconductor nanocrystal 200 may comprise InGaP. In various embodiments, the enhanced confinement nanocrystal may be typically shelled with either wider bandgap III-V or II-VI materials, with the latter being generally preferred. In one or more embodiments, the shell comprises ZnSe, and may comprise from 1 to 40 monolayers. In some embodiments, the shell may include ZnSe, ZnMgSe, ZnS, ZnSeS, ZnMgS, or ZnMgSeS, or multiple, differing layers of these shell materials. In one embodiment, the shell may consist of a monolayer or two of ZnSe, followed by 1 to 40 monolayers of ZnMgSe. In some embodiments, the shell may include ZnSe proximal to the core, followed by

ZnSeS distal to the core, and optionally, ZnS. In some embodiments, the shell may optionally further include some Cd. In one or more embodiments, the shell may have a crystal lattice constant within 10% of the lattice constant of the core nanocrystal. In an embodiment, the shelled nanocrystal has a radius at least 25% larger than the core nanocrystal, such as at least 50% larger than the core nanocrystal.

A number of standard processes known in the art can be followed for creating the colloidal semiconductor nanocrystal. In general, the processes may involve combining cation and anion precursors in appropriate solvents. The nanocrystal composition may be controlled by adjusting the ratios of precursors, the sequence of addition, reaction time, reaction temperature and other factors known in the art.

In accordance with an aspect of the present disclosure, the cation precursor used for synthesizing the colloidal semiconductor nanocrystal of the present disclosure may be a group II, III, or IV material. Some non-limiting examples of group II cation precursors are Cd(Me)₂, CdO, CdCO₃, Cd(Ac)₂, CdCl₂, Cd(NO₃)₂, CdSO₄, Cd oleate, Cd stearate, ZnO, ZnCO₃, Zn(Ac)₂, Zn(Et)₂, Zn stearate, Zn oleate, MgO, Mg stearate, Mg oleate, Hg₂O, HgCO₃ and Hg(Ac)₂. Some non-limiting examples of group III cation precursors are In(Ac)₃, InCl₃, In(acac)₃, In(Me)₃, In₂O₃, Ga(acac)₃, GaCl₃, Ga(Et)₃, and Ga(Me)₃. Some non-limiting examples of group IV cation precursors are alkylsilane and alkylgermane compounds. Other appropriate cation precursors well known in the art can also be used.

In some embodiments, the anion precursor used for the synthesis of the colloidal synthesis nanocrystal may be a material selected from a group consisting of S, Se, Te, N, P, As, and Sb (when the semiconducting material may be a II-VI, III-V, or IV-VI compound). Some examples of corresponding anion precursors are bis(trimethylsilyl)sulfide, tri-n-alkylphosphine sulfide, aminosulfide, hydrogen sulfide, tri-n-alkylphosphine selenide, aminoselenide, tri-n-alkylphosphine telluride, aminotelluride, bis(trimethylsilyl)telluride, tris(trimethylsilyl)phosphine, triethylphosphite, sodium phosphide, potassium phosphide, trimethylphosphine, tris(dimethylamino)phosphine, tricyclopentylphosphine, tricyclohexylphosphine, triallylphosphine, di-2-norbornylphosphine, dicyclopentylphosphine, dicyclohexylphosphine, dibutylphosphine, tris(trimethylsilyl)arsenide, sodium arsenide, and potassium arsenide. Other appropriate anion precursors known in the art can also be used.

Many high boiling point compounds exist that may be used both as reaction media (coordinating solvents) and, more importantly, as coordination (growth) ligands to stabilize the metal ion after it is formed from its precursor at high temperatures. These may also aid in controlling particle growth and impart colloidal properties to the nanocrystals. Among the different types of coordination ligands that can be used, some common ones are alkyl phosphine, alkyl phosphine oxide, alkyl phosphate, alkyl amine, alkyl phosphonic acid, and fatty acids. The alkyl chain of the coordination ligand is typically a hydrocarbon chain of length greater than 4 carbon atoms and less than 30 carbon atoms, which can be saturated, unsaturated, or oligomeric. The hydrocarbon chain may include one or more aromatic groups.

Non-limiting examples of suitable coordination (growth) ligands and ligand mixtures include, but are not limited to, trioctylphosphine, tributylphosphine, tri(dodecyl)phosphine, trioctylphosphine oxide, tributylphosphate, trioctyldecyl phosphate, trilauryl phosphate, tris(tridecyl)phosphate, triisodecyl phosphate, bis(2-ethylhexyl)phosphate, hexadecylamine, oleylamine, octadecylamine, bis(2-ethylhexyl)amine, octylamine, dioctylamine, cyclododecylamine, N,N-dimethyltetradecylamine, N,N-dimethyldodecylamine, phenylphosphonic acid, hexyl phosphonic acid, tetradecyl phosphonic acid, octylphosphonic acid, octadecyl phosphonic acid, propylphosphonic acid, aminohexyl phosphonic acid, oleic acid, stearic acid, myristic acid, palmitic acid, lauric acid, and decanoic acid. Further, they can be used by diluting the coordinating ligand with at least one solvent selected from a group consisting of, for example, 1-nonadecene, 1-octadecene, cis-2-methyl-7-octadecene, 1-heptadecene, 1-pentadecene, 1-tetradecenedioctylether, dodecyl ether, and hexadecyl ether, or the like.

In some embodiments to form nanocrystals comprising III-V materials, the growth ligands may include column II metals, such as Zn, Cd or Mg. In some embodiments, the zinc compound is zinc carboxylate having the formula:

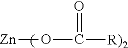

where R is a hydrocarbon chain of a length greater than or equal to 1 carbon atom and less than 30 carbon atoms. The hydrocarbon chain may be saturated, unsaturated, or oligomeric. The hydrocarbon chain may include one or more than one aromatic groups. Specific examples of suitable zinc compounds include, but are not limited to, zinc acetate, zinc undecylenate, zinc stearate, zinc myristate, zinc laurate, zinc oleate, zinc palmitate, or combinations thereof.

The solvents used in accordance with the present disclosure may be coordinating or non-coordinating, a list of possible candidates being given above. The solvent may have a boiling point above that of the growth temperature; as such, prototypical coordinating and non-coordinating solvents are trioctylphosphine and octadecene, respectively. However, in some cases, lower boiling solvents are used as carriers for the precursors; for example, tris(trimethylsilyl)phosphine can be mixed with hexane in order to enable accurate injections of small amounts of the precursor.

Examples of non-coordinating or weakly coordinating solvents include higher homologues of both saturated and unsaturated hydrocarbons. Mixture of two or more solvents can also be used. In some embodiments, the solvent may be selected from unsaturated high boiling point hydrocarbons, CH₃(CH₂)ₙCH═CH₂ wherein n is 7-30, such as, 1-nonadecene, 1-octadecene, 1-heptadecene, 1-pentadecene, or 1-eicosene, where the specific solvent used may be based on the reaction temperature of the nanocrystal synthesis.

When forming II-VI class shells, the shelling temperatures may typically be in a range of about 150° C. to about 300° C. In order to avoid the formation of nanocrystals composed solely of the shelling material, the shell precursors are either slowly dripped together from separately prepared solutions or the shell precursors are added one-half monolayer at a time (again typically at a slow rate). When using II-VI materials to shell III-V based colloidal semiconductor nanocrystal cores, the surfaces of the nanocrystals may be etched in weak acids [E. Ryu et al., Chem. Mater. 21, 573 (2009)] and then annealed at elevated temperatures (e.g., from 180° C. to 260° C.) prior to shelling. One example of a weak acid is acetic acid. As a result of the acid addition and annealing, the colloidal semiconductor nanocrystals tend to aggregate. In some embodiments, the ligands may be added to the growth solution prior to the initiation of the shelling procedure. Useful ligands include primary amines, such as, hexadecylamine, or acid-based amines, such as, oleylamine. As is well-known in the art, it may be also beneficial to anneal the nanocrystals near the shelling temperatures following each shelling step for times ranging from 10 to 60 minutes.

### General Synthetic Method for Forming Non-Homogeneous Cores

In a first primary step, a colloidal suspension of semiconductor nanocrystals having only the non-homogeneous inner core 202 is synthesized in a solvent. In order to create the non-homogeneous distribution profile of the first set of elements selected from a common group of the periodic table, their respective precursor materials and reaction conditions are selected so that the relative rate of inclusion of the two elements into the inner core portion varies during its formation. For example, in the case of type III-V semiconductors, the first set of elements are formed from first and second group III cation precursors that may have different reactivities with the group V anion precursor, and this reactivity profile may change as a function of time during the formation of the non-homogeneous inner core. In this example, the second group III precursor includes an element that forms a higher band gap material than the element of the first group III precursor. The size of the non-homogeneous inner cores are often small, so it might be helpful when the growth rates of the nanocrystals are constrained in order to enable nanocrystals of these sizes. For example, adding tetradecylphosphonic acid (TDPA) can significantly reduce growth rate in certain systems while enabling the formation of high quality nanocrystals.

As mentioned, the system may be designed so that the reactivities of the first and second cation precursors change differentially over time, e.g., via ligand exchange or other competing reactions, to create the unique and important energy-band profile. For example, the second cation precursor may initially have higher reactivity with the anion precursor than the first cation precursor. As the reaction progresses, however, ligand exchange reactions on the second cation precursor can produce a modified second cation precursor having lower reactivity with the anion precursor than the first cation precursor. The energy-band profile can alternatively be achieved or further modified by concentration and depletion (mass action) effects.

In a second primary step, the non-homogeneous outer core may be formed over the non-homogeneous inner core. Again using the non-limiting example of a type III-V semiconductor, this may be achieved through another addition of the second group III cation precursor after a period of time necessary for the non-homogeneous inner core to form, but before the first cation precursor is entirely consumed. This concentration boost will cause a rise in the atomic % of the second cation element within the nanocrystal and produce the inflection point in the band energy profile marking the beginning of the non-homogeneous outer core. The band energy rises to a peak level that, in an embodiment, corresponds to a maximum atomic % of the second cation.

After the second primary step and optional supplemental addition, the colloidal suspension of the nanocrystals is reduced in temperature and held for a period of time to fully form the nanocrystals of the present disclosure. Optionally, one or more supplemental additions of a group III or group V precursor is made while the nanocrystals fully form, for example, a slow addition of group V precursor. Optionally, a shell having one or more layers may be formed over the nanocrystal.

A non-limiting general procedure for forming an InGaP nanocrystal of the present disclosure is described below:
A) Adding into a flask a main reaction solution including a solvent, either coordinating (solvent reacts or forms bonds with the precursors or with the nanocrystal surface) or non-coordinating (solvent does not react or form bonds with precursors or with the nanocrystal surface), and optionally, some growth ligands;
B) Loading a first syringe with a first solution containing a solvent, an In precursor, a P precursor and optionally some growth ligands;
C) Loading a second syringe with a second solution containing a solvent, a Ga precursor, a P precursor and optionally some growth ligands;
D) Loading a third syringe with a third solution containing a solvent, a Ga precursor, optionally a P precursor and optionally some growth ligands;
E) Heating the flask of the main reaction solution to the nanocrystal nucleation temperature, e.g. in a range of about 265° C. to 315° C., while vigorously stirring its contents and while maintaining the first and second solutions at a temperature substantially below the nucleation temperature;
F) Contemporaneously injecting the contents of the first and second syringes into the heated flask to form a crude solution of the non-homogeneous inner cores 202. Typically, the formation of the non-homogeneous inner core happens very quickly;
G) Within a short time (e.g., 0 to 5 s) after injection of the first and second syringes is complete, the contents of the third syringe are injected to form the non-homogeneous outer core 204 of the colloidal semiconductor nanocrystals 200; and
H) Following the injections, the growth temperature may be lowered (typically 10° C. to 70° C. below that of the nucleation growth temperature) and the non-homogeneous outer core may be allowed to grow for the appropriate time (from about 1 to 120 minutes). During this growth period, additional precursors can be added to enhance the thickness of the outer region or to modify its semiconductor content.

The time it takes for the contemporaneous first and second injections, along with the subsequent growth rate of the non-homogeneous inner core 202 determines the time delay needed between steps F and G. By “contemporaneous” injection, it is not meant that the first and second syringe injections exactly start and end at the same precise time. That is, they don't have to be identical. Rather, it means that both syringes are being concurrently discharged into the reaction solution for at least 50% of the total, combined injection time. A non-identical contemporaneous injection of precursor solutions can also be used to help create the non-homogeneous distribution in the non-homogeneous inner core. Typically, the above process may be performed under airless conditions involving conventional gloveboxes and Schlenk lines.

The solvents used in the first, second or third syringe may be coordinating or non-coordinating, a list of possible candidates being given above. In some embodiments, the solvent may have a boiling point above that of the growth temperature; however, in some cases, lower boiling solvents are used as carriers for the precursors, such as, hexane or heptane. The list of possible growth ligands has been discussed above. Candidate anion and cation precursors have also been discussed above.

The method described above can be modified, e.g., by providing one of the precursor materials needed to form the non-homogeneous inner core in the main reaction solution rather than in one of the syringes. For example, the P precursor could have been provided in the main reaction solution and the contents of the corresponding first or second syringe could be modified

### EXAMPLES

It should be understood that the following examples are provided to illustrate embodiments described in this disclosure and are not intended to limit the scope of this disclosure or its appended claims.

### Example 1: Preparation of Enhanced Semiconductor Nanocrystals with Magnesium-Free Buffer Zone, InGaP/ZnSe/ZnMgSeS

InGaP core nanocrystals, in this case having non-homogeneous inner and outer cores, were prepared as follows. A flask was filled with 9 ml of octadecene (ODE), 45 mg of Zn undecylenate and 120 mg of myristic acid. The mixture was degas sed at 100° C. for 1.5 hours. After switching to N₂ overpressure, the flask contents were heated to 300° C., while vigorously stirring its contents. Three precursor solutions were prepared and loaded into corresponding syringes. The first precursor solution contained 7.8 mg trimethylindium (TMIn), 5.9 μl of tris(trimethylsilyl)phosphine (P(TMS)3), 15.8 μl of oleylamine, 69 μl of hexane and 1.4 ml ODE; the second precursor solution contained 5 μl of triethylgallium (TEGa), 5.9 μl of tris(trimethylsilyl)phosphine (P(TMS)3), 9.4 μl of oleylamine, 113 μl of hexane and 1.39 ml of ODE; and the third precursor solution contained 15.5 μl of triethylgallium (TEGa), 26.3 μl of oleylamine, 140 μl of hexane and 2.44 ml of ODE. When the reaction flask reached 300° C., the first and second syringes were simultaneously injected quickly by hand into the hot flask to form a non-homogeneous inner core of InGaP. After a time delay of about 1-2 sec, the third syringe was rapidly injected into the hot flask by hand to form a non-homogeneous outer core of InGaP. After the third injection, the flask temperature was lowered to about 270° C. and the nanocrystals were grown for 10-20 minutes in total. The reaction was stopped by removing the heating source.

The InGaP core nanocrystals were shelled with wider bandgap II-VI materials. The shelling began with a weak acid etch of the nanocrystals. After the reaction flask was cooled to room temperature under continuous stirring, 200 μl acetic acid was loaded into a syringe and then injected into the flask. This was followed by annealing the contents of the flask for 60 minutes at 190° C. Since the nanocrystals aggregated following this step, 0.5 ml of oleylamine was injected into the flask. The contents were then annealed at 190° C. for 10 minutes.

ZnSe/ZnMgSeS shells were grown on the etched nanocrystals at 190° C. by the following procedure. The precursor solutions containing Zn, Mg, Se, and S were prepared in a glovebox prior to growing the shells. The first solution of 315 μl of diethylzinc (DEZ) solution (1 M DEZ in hexane) and 1.5 ml of ODE was added dropwise to the reaction mixture under vigorous stirring; the flask contents were then annealed at 190° C. for 15 minutes to form approximately one-half monolayer of Zn. A second solution of 28 mg of Se powder, 200 μl of tri-n-butylphosphine, and 1.5 ml of ODE was then added dropwise to the reaction mixture under vigorous stirring; the flask contents were then annealed at 190° C. for 15 minutes to form approximately one-half monolayer of Se. For the remainder of the shells the Zn and Mg precursors were stearate-based. For example, the Zn stearate solution was formed by combining 2.5 g of Zn stearate powder, 12 ml of ODE, 2.5 ml of tri-n-octylphosphine, and 2.5 ml of oleylamine. The stearate solution turns clear when vigorously stirring at 150 C. For the second shell, the syringe solution contained 1.11 ml of Zn(St)₂ solution, 905 μl of Mg(St)₂ solution, and 0.2 ml of oleylamine. The solution was added dropwise to the reaction mixture under vigorous stirring; the flask contents were then annealed at 190° C. for 15 minutes to form approximately one-half monolayer of ZnMg. A second solution of 7.3 mg of Se powder, 11.9 mg of S powder, 200 μl of tri-n-butylphosphine, and 1.3 ml of ODE was then added dropwise to the reaction mixture under vigorous stirring; the flask contents were then annealed at 190° C. for 15 minutes to form approximately one-half monolayer of SeS. Subsequent ZnMgSeS shells were added in a similar fashion, with shell monolayers up to 10 being formed.

Relative quantum yield measurements were performed on the nanocrystals by procedures well-known in the art. The comparison fluorescent material was Rhodamine 6G, which has an absolute quantum efficiency of 95%. The crude nanocrystal suspensions were washed using procedures well-known in the art and the washed nanocrystals were mixed with toluene to make the quantum yield measurements. The resulting nanocrystals of Example 1 had relative quantum efficiencies in the range of 70-80% (at room temperature) at an excitation wavelength of 470 nm. Additional testing on nanocrystals similar to those of Example 1 finds that high quantum efficiencies are maintained at highly elevated temperatures and excitation optical flux densities under air-free conditions.

### Comparative 1: Preparation of InGaP/ZnMgSeS Nanocrystals without Magnesium-Free Buffer Zone

Comparative 1 nanocrystals were prepared in the same manner as Example 1, but without the magnesium-free, ZnSe buffer zone. Comparative 1 nanocrystals had a relative quantum efficiency of only 14-30% (room temperature) at an excitation wavelength of 470 nm. Clearly, nanocrystals with shells including a magnesium-free buffer zone positioned between the III-V core and a magnesium-containing zone have much higher quantum efficiencies (up to a factor of 5) compared to nanocrystals not having the magnesium-free buffer zone.

As described above, the author has found that incorporating Mg into ZnSeS based shells, to form ZnMgSeS shells, results in an increase in both electron and hole confinement due to the bandgap of MgSeS being significantly larger than that of ZnSeS. High quantum efficiencies were unexpectedly achieved by addition of a buffer zone and high quantum efficiencies are maintained even at highly elevated temperatures and excitation optical flux densities under air-free conditions. Given these advantages, it would be desirable to employ these types of nanocrystals for commercial application in both solid state lighting and display. Unfortunately, it is well known from conventional semiconductor device work that Mg-based materials are highly sensitive to oxygen and water [M. Sohel et. al., Appl. Phys. Lett. 85, 2794 (2004)]. Phosphors employed for solid state lighting are typically encased in silicones, which are permeable to air and moisture. For commercial viability, therefore, nanocrystal-based phosphor material are preferably stable in air. As described below, the author has unexpectedly found that adding an outer shell of ZnSeS over the magnesium-containing zone render the nanocrystals much more stable to air and moisture.

### Example 2: Preparation of Enhanced Semiconductor Nanocrystals with Magnesium-Free Outer Shell, InGaP/ZnSe/ZnMgSeS/ZnSeS

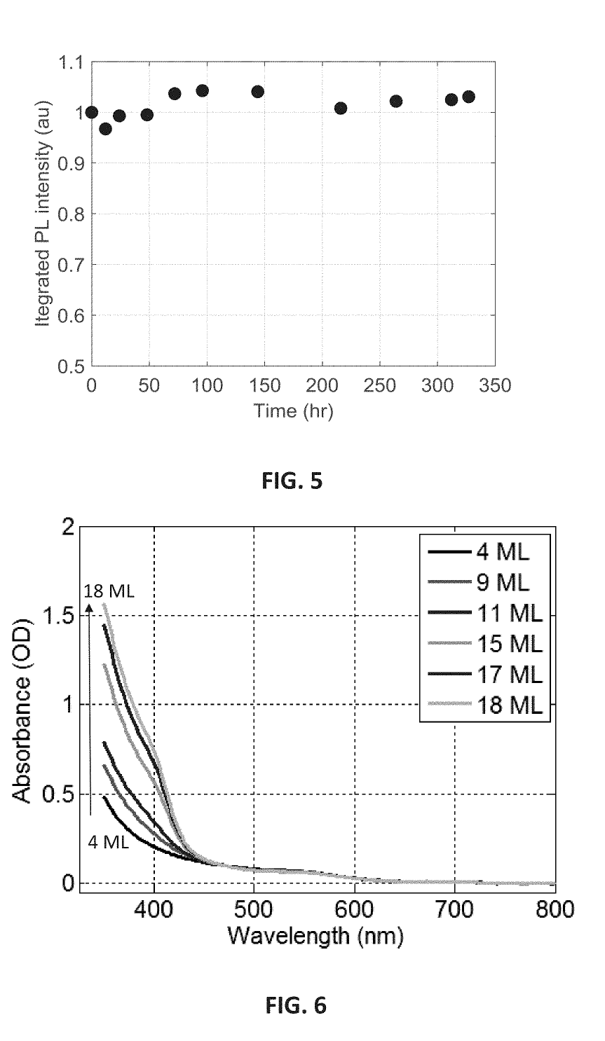

The nanocrystal core and shell compositions, in addition to the corresponding synthetic procedures, are analogous to those employed for Example 1, except that monolayers of ZnSeS are added as an outer shell. As with Example 1, the nanocrystals contain a magnesium-free ZnSe buffer layer between the InGaP core and the ZnMgSeS shells. For this example, the nanocrystal contained 4 monolayers of ZnMgSeS and 10-18 monolayers of ZnSeS. For the ZnMgSeS shell, the fractional molar ratio of Zn/Mg cation precursors was 55/45, and the fractional molar ratio of Se/S anion precursors was ¼. For the outer ZnSeS shell, the fractional molar ratio of Se/S anion precursors was 2/1. FIG. 5 shows long-term stability data of the Example 2 nanocrystals which were placed in a silicone-based film along with conventional rare-earth-based phosphors. Since the rare-earth phosphors are stable in time, it is straightforward to extract the nanocrystal response from the overall phosphor spectra. The film was placed in open glass vials and excited by a blue 450 nm laser diode. The measured excitation power density was 18 W/cm². The air temperature was 25° C., with 40% RH. The glass vials were not heat sunk; thus, the film temperature was above ambient due to Stokes loss and the quantum efficiency being <100% (the measured quantum efficiency of the nanocrystals was ˜75%). As can be seen from FIG. 5, the integrated nanocrystal response is stable for at least up to about 330 hrs.

By comparison, films of nanocrystals formed as described in Example 1 were formed using both acrylate and silicone-based matrices. Though, as discussed above, these nanocrystals maintained very high efficiencies at elevated temperatures and excitation flux densities, their stability in air was very poor. Numerous tests were conducted, and in all cases, the nanocrystal efficiency falls off by at least a factor of 3 after only 60 minutes of excitation at low power density values of ˜1 W/cm². As can be seen, the nanocrystals have significantly improved air-stability when employing outer shells of ZnSeS.

The added layers of ZnSeS are surprisingly effective in preventing the rapid degradation of the underlying ZnMgSeS layers under ambient conditions and the concomitant fall-off of the nanocrystal efficiency. In combination with a magnesium-free buffer layer, nanocrystals can be formed that have both high quantum efficiency and high stability in matrices that are air or moisture permeable.

### Example 3: Preparation of Shelled Enhanced-Confinement Nanocrystals of the Present Disclosure, InGaP/ZnSe/ZnMgSe

InGaP core nanocrystals having non-homogeneous inner- and outer-cores were prepared in the same way as described in Example 1. The InGaP enhanced-confinement colloidal semiconductor nanocrystals were shelled with wider bandgap II-VI materials. As per Example 1, the shelling began with a weak acid etch of the nanocrystals.

ZnSe/ZnMgSe-based shells were grown on the etched nanocrystals at 190° C. by the following procedure. The precursor solutions containing Zn, Mg, and Se were prepared in a glovebox prior to growing the shells. The first solution of 563 μl of diethylzinc (DEZ) solution (10% DEZ in hexane) and 0.9 ml of ODE was added dropwise to the reaction mixture under vigorous stirring; the flask contents were then annealed at 190° C. for 10 minutes to form approximately one-half monolayer of Zn. A second solution of 28 mg of Se powder, 200 μl of tri-n-butylphosphine, and 1.0 ml of ODE was then added dropwise to the reaction mixture under vigorous stirring; the flask contents were then annealed at 190° C. for 10 minutes to form approximately one-half monolayer of Se. For the remainder of the shells the Zn and Mg precursors were stearate-based. For the second shell, the syringe solution contained 1.34 ml of Zn(St)₂ solution, 670 ul of Mg(St)₂ solution, and 0.1 ml of oleylamine. The solution was added dropwise to the reaction mixture under vigorous stirring; the flask contents were then annealed at 190° C. for 15 minutes to form approximately one-half monolayer of ZnMg. A second solution of 37 mg of Se powder, 200 μl of tri-n-butylphosphine, and 1.2 ml of ODE was then added dropwise to the reaction mixture under vigorous stirring; the flask contents were then annealed at 190° C. for 15 minutes to form approximately one-half monolayer of Se. Subsequent ZnMgSe shells were added in a similar fashion, with shell monolayers up to 20 being formed.

The resulting nanocrystals of Example 3 had relative quantum efficiencies in the range of 75-85% (at room temperature) at an excitation wavelength of 470 nm. The nanocrystals had typical emission peak wavelengths of approximately 585 nm, with spectral full-width at half maximum (FWHM) of approximately 80 nm.

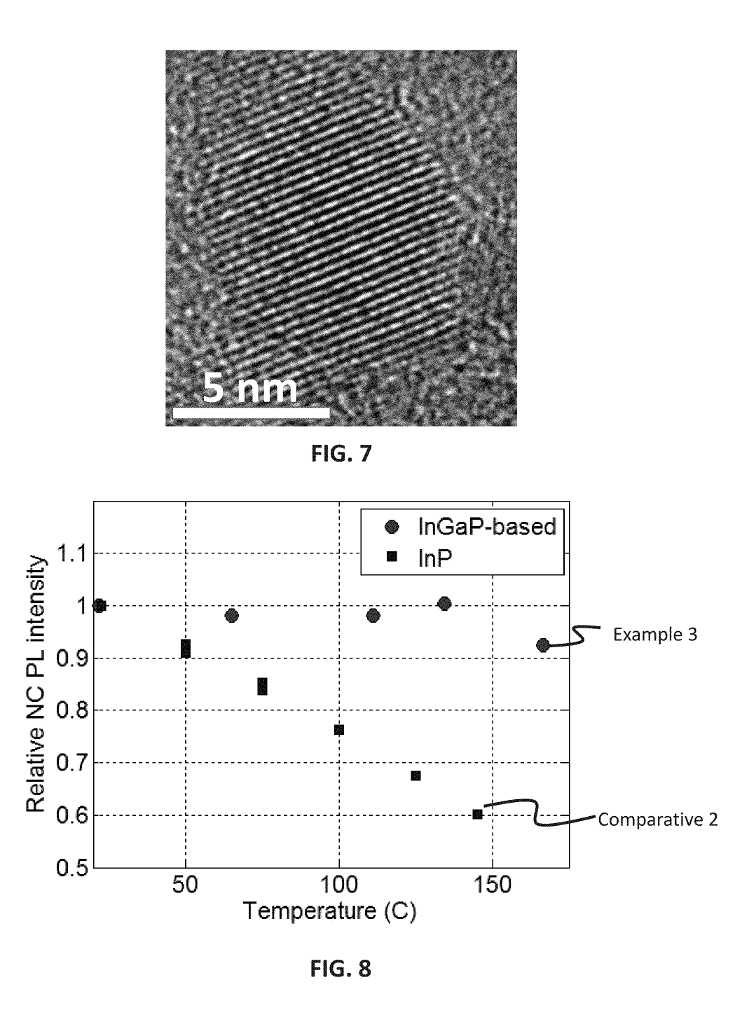

FIG. 6 shows the UV-Vis absorbance spectrum of the InGaP nanocrystal with increasing monolayers (ML) of the ZnMgSe shell. The absorbance below 450 nm increases with increasing number of monolayers. The bulk bandgap of the shell may be about 430 nm, which equates to a Mg content of 30% (close to the precursor value of 33%). FIG. 7 is an HRTEM image of the core-shell nanocrystal of this Example 3, with the ZnMgSe shells being 18 ML thick. The shelled nanocrystal size is about 8.3×11.6 nm. The fringe spacing is 0.33 nm, slightly above that for zinc-blende ZnSe of 0.32.

### Comparative 2: Preparation of Conventional InP/ZnSe/ZnSeS/ZnS Nanocrystals

Comparative conventional InP/ZnSe/ZnSeS/ZnS nanocrystals were synthesized as described in Example 1-3 of U.S. Pat. No. 9,153,731. These nanocrystals had conventional, homogeneous cores of InP. The conventional nanocrystals had a relative quantum efficiency of 62% (room temperature) at an excitation wavelength of 470 nm. The nanocrystals had an emission peak at 561 nm and a spectral FWHM of 60 nm.

### Temperature-Dependent Photoluminescence (PL) Measurements

The temperature dependences of the PL responses of the nanocrystals were measured from room temperature up to about 167° C. for Example 3 and up to about 150° C. for the Comparative 2 nanocrystals. The measurements were performed under airless conditions using nanocrystals suspended in trichlorobenzene solutions. The nanocrystals were excited at 405 nm, with a calculated (based on the absorbance ratio of approximately 4.0) flux density at 450 nm of 10 W/cm2 and 0.03 W/cm2 for the Example 3 and Comparative 2 nanocrystals, respectively.

The results of the measurements are shown in FIG. 8 for Example 3 “InGaP-based” nanocrystals along with conventional Comparative 2 “InP” nanocrystals. The figure plots relative nanocrystal (NC) PL intensity in arbitrary units as a function of temperature. The PL intensity of Example 3 does not fall at all through 130° C. and falls only about 8% at 167° C., the highest temperature tested. In contrast, the PL intensity of Comparative 2 steadily decreases with increasing temperature, showing a 35% reduction at 130° C. and extrapolates to about a 50% reduction at 167° C. Thus, Example 3 shows a significant improvement in PL intensity at elevated temperatures over conventional nanocrystals. The results are further significant in that there is a 300× higher excitation flux density for the Example 3 nanocrystals compared to conventional nanocrystals; raising the conventional nanocrystal flux density to 10 W/cm² would likely result in further loss of PL at higher temperatures. The authors are not aware of any conventional colloidal nanocrystals having this high performance. In reference U.S. Pat. No. 9,153,731, even the best examples of their disclosed InGaP-based nanocrystals lose 14-15% or more intensity at 145° C. Interpolating the graph in FIG. 8, Example 3 of the present disclosure has only a 3-4% reduction in PL intensity at 145° C., at a much higher flux density compared to conventional nanocrystals. Accounting for the small fall-off in absorbance at 167° C., the resulting QE loss for the InGaP NCs is <5% at 167° C.

### Flux-Dependent (cw) and Temperature-Dependent Photoluminescence Measurements

The PL response of nanocrystals of Example 3 was also determined under various temperature and excitation power flux density conditions. Dilute solutions of the nanocrystals in trichlorobenzene were placed in air-free cuvettes. The nanocrystals were excited by a 120 mW 405 nm laser diode. A beam expander in combination with a 200-mm focusing lens was used to obtain a 1/e² spot size of 14 μm. The nanocrystal concentration was adjusted so that over the about 1 mm pathlength of the cuvette, the laser diode power flux density remained invariant.

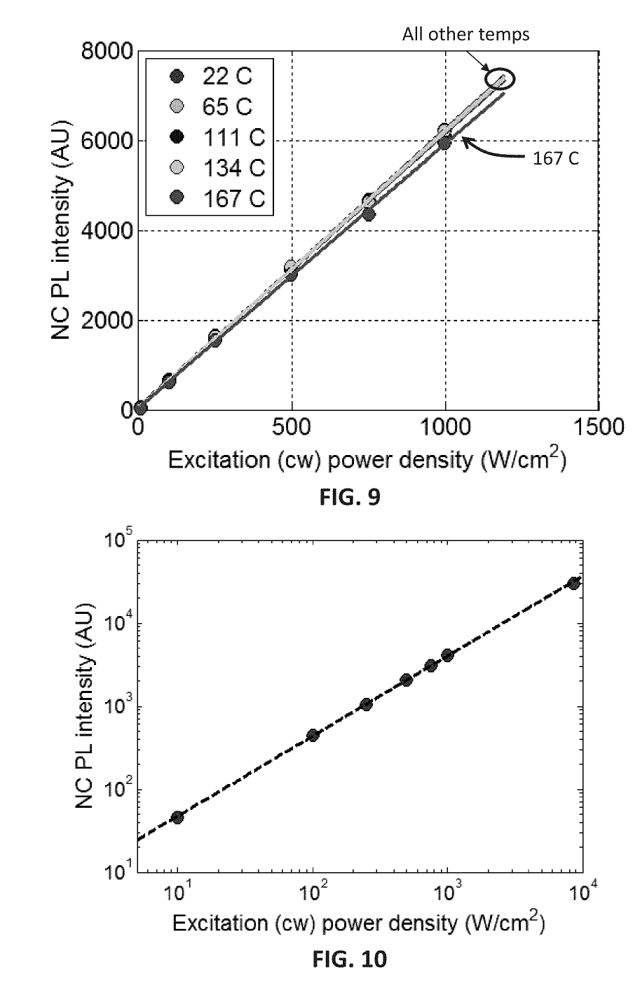

FIG. 9 shows the photoluminescent intensity in arbitrary units for nanocrystals of Example 3 as a function of excitation power density (W/cm²) at numerous temperatures ranging from 22° C. to 167° C. The various lines fall on top of each other for all temperatures except 167° C., which is just barely different. The linearity of the data shows that the quantum efficiency of emission remains unchanged over the excitation power densities tested. Additional measurements were done (not shown) to verify that the quantum efficiency (QE) remained unchanged from 0.1 to 50 W/cm². Tests for conventional InP-type nanocrystals, such as Comparative 2 (not shown), show a fall-off in PL with increasing excitation flux density. Conventional nanocrystals cannot maintain performance under both high temperature and high excitation flux as well as the nanocrystals of the present disclosure.

FIG. 10 is similar to FIG. 9 but extends the 167° C. data to include excitation power densities higher by several orders of magnitude. One can see that the QE of the Example 3 nanocrystals may be still remarkably invariant even up to approximately 9 kW/cm² flux at this high temperature of 167° C. At the 9 kW/cm² flux level, the photoluminescence remained unchanged for a least 10 minutes. Conventional nanocrystals cannot maintain such performance at high flux and high temperatures.

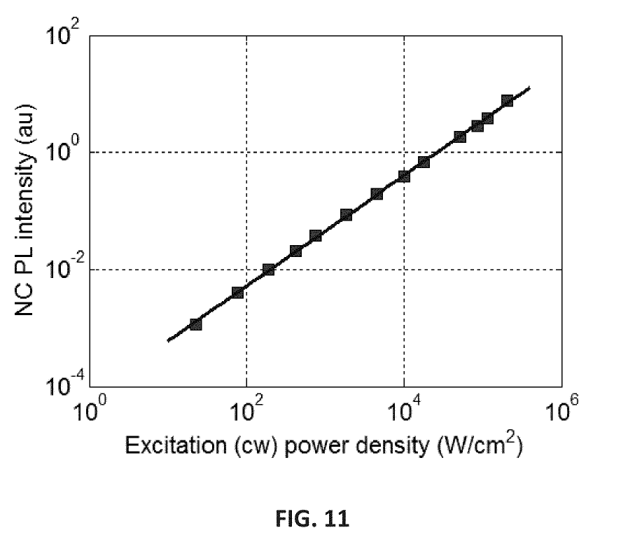

FIG. 11 is similar to FIGS. 9 and 10, but extends the power flux density even further, this time for Example 3 nanocrystals held at 25° C. The excitation was at 405 nm and the highest flux levels were 206 kW/cm². Even under these extremely high excitation flux conditions, the QE remains effectively invariant. Further, the nanocrystals did not show any loss in photoluminescence intensity for at least 120 minutes. Conventional nanocrystals cannot maintain such performance under such high flux conditions, including the nanocrystals of U.S. Pat. No. 9,153,731. The present results are very surprising. Referring to FIG. 1B of U.S. Pat. No. 9,153,731, one would have expected such a format to provide the highest exciton confinement because it should maximize the delta band-energy barrier between the homogeneous region and the peak. In the present disclosure, the non-homogeneous inner core does not start from as low a band energy as conventional nanocrystals, thus, the delta band-energy barrier between the inflection point and the peak level may be reduced relative to conventional nanocrystals. Despite these energetics, the nanocrystals of the present disclosure show performance that can be significantly better than conventional nanocrystals, which is a very counterintuitive result.

In some embodiments, the colloidal semiconductor nanocrystal may have a photoluminescence quantum efficiency (PLQE) of at least 70% at 25° C., and a PLQE at 150° C. that is at least 90% of the PLQE at 25° C. In some embodiments, the colloidal semiconductor nanocrystal may have less than or equal to 5 wt % Cd, and in some embodiments, may be essentially Cd-free (such as less than or equal to 3 wt % Cd, less than or equal to 2 wt % Cd, or less than or equal to 1 wt % Cd) and have a PLQE of at least 70% at 25° C., and a PLQE at 150° C. that is at least 90% of the PLQE at 25° C. In some embodiments, the colloidal semiconductor nanocrystal may have a PLQE of at least 70% at 25° C., and a PLQE at 150° C. that is at least 90% of the PLQE at 25° C. for an excitation flux density greater than or equal to 25 W/cm², such as greater than or equal to 30 W/cm², 50 W/cm², 100 W/cm², or 200 W/cm². In some embodiments, the nanocrystal may be essentially Cd-free (such as less than or equal to 3 wt % Cd, less than or equal to 2 wt % Cd, or less than or equal to 1 wt% Cd) and may have a PLQE of at least 70% at 25° C., and a PLQE at 150° C. that is at least 90% of the PLQE at 25° C. for an excitation flux density greater than or equal to 25 W/cm², such as greater than or equal to 30 W/cm², 50 W/cm², 100 W/cm², or 200 W/cm².

All references mentioned in this disclosure are incorporated by reference herein.

### Aspects of the Disclosure

In a first aspect, the disclosure provides a nanocrystal comprising a III-V class semiconductor core and a II-VI class semiconductor shell that at least partially coats the core, the shell comprising a magnesium-containing first zone and a magnesium-free buffer zone provided between the core and the first zone.

In a second aspect, the disclosure provides a nanocrystal of the first aspect wherein the first zone comprises ZnMgSe, ZnMgS, ZnMgSeS, CdMgSe, CdMgS, CdMgSeS or combinations thereof.

In a third aspect, the disclosure provides a nanocrystal of the first aspect or the second aspect, wherein the first zone is 1 to 20 monolayers thick.

In a fourth aspect, the disclosure provides a nanocrystal of the first aspect through third aspect, wherein the buffer zone comprises ZnSe, ZnS, ZnSeS, CdSe, CdS, CdSeS or combinations thereof.

In a fifth aspect, the disclosure provides a nanocrystal of the first through fourth aspect, wherein the buffer zone is 1 to 4 monolayers thick.

In a sixth aspect, the disclosure provides a nanocrystal of the first through fifth aspect wherein the first zone is thicker than the buffer zone.

In a seventh aspect, the disclosure provides a nanocrystal of the first through sixth aspect, wherein the core comprises a binary, ternary or quaternary semiconductor material.

In an eighth aspect, the disclosure provides a nanocrystal of the first through seventh aspect, wherein the core comprises a ternary or quaternary semiconductor material having a non-homogeneous distribution of components.

In a ninth aspect, the disclosure provides a nanocrystal of the seventh or eighth aspect, wherein the core comprises Al, Ga or In, or combinations thereof.

In a tenth aspect, the disclosure provides a nanocrystal of the seventh through ninth aspect, wherein the core comprises P, N, As, or Sb, or combinations thereof.

In an eleventh aspect, the disclosure provides a nanocrystal of the first through tenth aspect, wherein the shell fully coats the core.

In a twelfth aspect, the disclosure provides a nanocrystal comprising a semiconductor core and a II-VI class semiconductor shell that at least partially coats the core, the shell including a magnesium-containing first zone proximal to the core, a second zone distal from the core, the second zone having less magnesium than the first zone and a magnesium-free buffer zone provided between the core and the first zone.

In a thirteenth aspect, the disclosure provides a nanocrystal of the twelfth aspect, wherein the first zone comprises ZnMgSe, ZnMgS, ZnMgSeS, CdMgSe, CdMgS, CdMgSeS or combinations thereof.

In a fourteenth aspect, the disclosure provides a nanocrystal of the twelfth or thirteenth aspect, wherein the first zone is 1 to 20 monolayers thick.

In a fifteenth aspect, the disclosure provides a nanocrystal of the twelfth through fourteenth aspect, wherein the second zone is substantially free of magnesium.

In a sixteenth aspect, the disclosure provides a nanocrystal of the twelfth through fifteenth aspect wherein the second zone comprises ZnSe, ZnS, ZnSeS, CdSe, CdS, CdSeS or combinations thereof.

In a seventeenth aspect, the disclosure provides a nanocrystal of the twelfth through fifteenth aspect, wherein the second zone is thicker than the first zone.

In a eighteenth aspect, the disclosure provides a nanocrystal of the twelfth through seventeenth aspect wherein the second zone is 1 to 20 monolayers thick.

In a nineteenth aspect, the disclosure provides a nanocrystal of the twelfth aspect, wherein the buffer zone comprises ZnSe, ZnS, ZnSeS, CdSe, CdS, CdSeS or combinations thereof.

In a twentieth aspect, the disclosure provides a nanocrystal of the nineteenth aspect, wherein the buffer zone is thinner than the first or second zones.

In a twenty-first aspect, the disclosure provides a nanocrystal of the nineteenth or twentieth aspect, wherein the buffer zone is 1 to 4 monolayers thick.

In a twenty-second aspect, the disclosure provides a nanocrystal of the twelfth through twenty-first aspect, wherein the core comprises a III-V class semiconductor material.

In a twenty-third aspect, the disclosure provides a nanocrystal of the twelfth through twenty-second aspect, wherein the core comprises a binary, ternary or quaternary semiconductor material.

In a twenty-fourth aspect, the disclosure provides a nanocrystal of the twelfth through twenty-third aspect, wherein the core comprises ternary or quaternary semiconductor material having a non-homogeneous distribution of components.

In a twenty-fifth aspect, the disclosure provides a nanocrystal of the twenty-third or twenty-fourth aspect, wherein the core comprises Al, Ga or In, or combinations thereof.

In a twenty-sixth aspect, the disclosure provides a nanocrystal of the twenty-third through twenty-fifth aspect, wherein the core comprises P, N, Sb, or As, or combinations thereof.

In a twenty-seventh aspect, the disclosure provides a nanocrystal of the twelfth through twenty-sixth aspect, wherein the core comprises InP, GaP, AlP, InN, GaN, AN, InSb, GaSb, AlSb, InAs, GaAs, AlAs, or combinations, thereof.

In a twenty-eighth aspect, the disclosure provides a nanocrystal of the twelfth through twenty-seventh aspect, wherein the shell fully coats the core.

In a twenty-ninth aspect, the disclosure provides a nanocrystal comprising a ternary or quaternary III-V class semiconductor core and a II-VI class semiconductor shell that at least partially coats the core, the shell comprising ZnMgSe, ZnMgS, ZnMgSeS, CdMgSe, CdMgS,

CdMgSeS or combinations thereof.

In a thirtieth aspect, the disclosure provides a nanocrystal of the twenty-ninth aspect, wherein the core has a non-homogeneous distribution of components.

In a thirty-first aspect, the disclosure provides a nanocrystal of the twenty-ninth aspect or the thirtieth aspect, wherein the core comprises Al, Ga or In, or combinations thereof.

In a thirty-second aspect, the disclosure provides a nanocrystal of the twenty-ninth through thirty-first aspect, wherein the core comprises P, N, As, or Sb, or combinations thereof.

In a thirty-third aspect, the disclosure provides a nanocrystal of the twenty-ninth through thirty-second aspect, wherein the core comprises InGaP

In a thirty-fourth aspect, the disclosure provides a nanocrystal of the twenty-ninth through thirty-third aspect, wherein the shell fully coats the core.

In a thirty-fifth aspect, the disclosure provides a layer comprising a matrix material and nanocrystals according to any of the first aspects through the thirty-fourth aspects dispersed therein.

In the thirty-sixth aspect, the disclosure provides a layer of the thirty-fifth aspect, wherein the matrix comprises a silicone, a polymer or a glass.

In a thirty-seventh aspect, the disclosure provides a solid-state lighting or display device comprising the layer of thirty-fifth or thirty-sixth aspect.

In the thirty-sixth aspect, the disclosure provides a nanocrystal comprising: a non-homogeneous inner core having a first non-uniform band energy profile; and a non-homogeneous outer core having a second non-uniform band energy profile, wherein the non-homogeneous outer core at least partially coats the non-homogeneous inner core, and the second non-uniform band energy profile comprises a peak level higher than any peak level of the first non-uniform band energy profile; and wherein the nanocrystal is a colloidal semiconductor.

In a thirty-ninth aspect, the disclosure provides a nanocrystal of the thirty-eighth aspect, wherein the first non-uniform band energy profile, the second non-uniform band energy profile, or both, is an electron band energy profile.

In a fortieth aspect, the disclosure provides a nanocrystal of the thirty-eighth aspect or the thirty ninth aspect, wherein the first non-uniform band energy profile, the second non-uniform band energy profile, or both, is a hole band energy profile.

In a forty-first aspect, the disclosure provides a nanocrystal of the thirty-eighth throught the fortieth aspect, wherein the non-homogeneous inner core comprises a first semiconductor material, and the first semiconductor material comprises at least two elements from the same periodic table group, and wherein the non-homogeneous outer core comprises a second semiconductor material, and the second semiconductor material comprises at least two elements selected from the same periodic table group.

In a forty-second aspect, the disclosure provides a nanocrystal of the forty-first aspect, wherein the first semiconductor material and the second semiconductor material are the same.

In a forty-third aspect, the disclosure provides a nanocrystal of the forty-first aspect or forty-second aspect, wherein the first semiconductor material and the second semiconductor material are III-V, II-VI, IV, or IV-VI class semiconductors.

In a forty-fourth aspect, the disclosure provides a nanocrystal of the forty-first through forty-third aspect, wherein the first semiconductor material and the second semiconductor material are III-V class semiconductors, and the first semiconductor material comprises at least two group-III elements or at least two group-V elements.

In a forty-fifth aspect, the disclosure provides a nanocrystal of the forty-first through forty-fourth aspect, wherein the second semiconductor material comprises at least two group-III elements or at least two group-V elements.

In a forty-sixth aspect, the disclosure provides a nanocrystal of the forty-first through forty-fifth aspect, wherein, the first semiconductor material and the second semiconductor material comprise at least two group-III elements, at least two group-V elements, or both.

In a forty-seventh aspect, the disclosure provides a nanocrystal of the forty-first through forty-sixth aspect, wherein the group-III elements are selected from the group consisting of Ga, In, Al, and combinations thereof, and the group-V elements are selected from the group consisting of P, N, Sb, and combinations thereof.

In a forty-eighth aspect, the disclosure provides a nanocrystal of the forty-first through forty-seventh aspect, wherein the non-homogeneous inner core comprises InGaP in a first non-homogeneous distribution of In and Ga, and the non-homogeneous outer core comprises InGaP in a second non-homogeneous distribution of In and Ga, wherein the first non-homogeneous distribution is different than the second non-homogeneous distribution.

In a forty-ninth aspect, the disclosure provides a nanocrystal of the thirty-eighth through forty-eighth aspect, wherein the non-homogeneous inner core and the non-homogeneous outer core both comprise InGaP, and the overall atomic % of Ga in the non-homogeneous outer core is higher than the overall atomic % of Ga in the non-homogeneous inner core.

In a fiftieth aspect, the disclosure provides a nanocrystal of the thirty-eighth through forty-ninth aspect, wherein the nanocrystal comprises a center and an outer edge, and the nanocrystal has a nanocrystal band energy profile from the center to the outer edge that includes a nanocrystal inflection point corresponding to a beginning of the non-homogeneous outer core, wherein the nanocrystal band energy level increases from the nanocrystal inflection point to a nanocrystal peak level.

In a fifty-first aspect, the disclosure provides a nanocrystal of the fiftieth, wherein the beginning of the non-homogeneous outer core is closer to the nanocrystal center than to the outer edge.

In a fifty-second aspect, the disclosure provides a nanocrystal of the thirty-eighth through fifty-first aspect, wherein the non-homogeneous inner core has a radius of from 0.5 to 1.5 nanometers (nm) and the non-homogeneous outer core has a thickness of from 0.75 to 2.0 nm.

In a fifty-third aspect, the disclosure provides a nanocrystal of the thirty-eighth through fifty-second aspect, wherein the non-homogeneous inner core has a radius that is about ⅛ to about ⅓ of the radius of the overall nanocrystal.

In a fifty-fourth aspect, the disclosure provides a nanocrystal of the thirty-eighth through fifty-third aspect, wherein the nanocrystal peak level is at least 20% higher than a highest level of the non-uniform band energy profile of the non-homogenous inner core

In a fifty-fifth aspect, the disclosure provides a nanocrystal of the thirty-eighth through fifty-fourth aspect, wherein the nanocrystal peak level is closer to the beginning of the non-homogeneous outer core than it to the outer edge.

In a fifty-sixth aspect, the disclosure provides a nanocrystal of the thirty-eighth through fifty-fifth aspect, the nanocrystal further comprises a shell at least partially covering the outer edge to form a shelled nanocrystal.

In a fifty-seventh aspect, the disclosure provides a nanocrystal of the fifty-sixth aspect, wherein the shelled nanocrystal has a radius at least 25% larger than the nanocrystal without the shell.

In a fifty-eighth aspect, the disclosure provides a nanocrystal of the fifty-sixth aspect or fifty-seventh aspect, wherein the shell comprises a II-VI semiconductor.

In a fifty-ninth aspect, the disclosure provides a nanocrystal of the fifty-eighth, wherein the shell comprises ZnSe, ZnMgSe, ZnS, ZnSeS, ZnMgS, ZnMgSeS, or combinations thereof.

In a sixtieth aspect, the disclosure provides a nanocrystal of the fifty-sixth through fifty-ninth, wherein the shell comprises 1-40 monolayers.

In a sixty-first aspect, the disclosure provides a nanocrystal of the thirty-eighth through sixtieth, wherein the nanocrystal comprises less than or equal to 5 weight percent (wt %) of arsenic, cadmium, or both.

In a sixty-second aspect, the disclosure provides a nanocrystal of the first through sixty-first, wherein the nanocrystal has a photoluminescence quantum efficiency (PLQE) of at least 70% at 25° C., and a PLQE at 150 ° C. that is at least 90% of the PLQE at 25° C.

In a sixty-third aspect, the disclosure provides a nanocrystal of the sixty-second, wherein the PLQE at 150° C. is at least 95% of the PLQE at 25° C.

In a sixty-second aspect, the disclosure provides a nanocrystal of the sixty-second or sixty-third, wherein the PLQE at 25° C. changes less than 10% for an excitation power density range of 1 to 5,000 W/cm².

In a sixty-fourth aspect, the disclosure provides a method of making nanocrystals, the method comprising: heating a reaction solution comprising at least one solvent and optionally at least one ligand to a first temperature to form a heated reaction solution; combining the heated reaction solution contemporaneously with a first precursor solution comprising a first element and a second precursor solution including a second element, wherein the first precursor solution and the second precursor solution react at different rates; forming a suspension of intermediate nanocrystals having a non-homogeneous distribution of the first and the second element; and adding to the suspension of intermediate nanocrystals a solution comprising a third precursor material including a third element to form a suspension of nanocrystals having a non-homogeneous outer core having a non-homogeneous distribution of the first element, the second element, and the third element that differs from a distribution in a non-homogeneous inner core.

In a sixty-fifth aspect, the disclosure provides a nanocrystal of the sixty-fourth aspect, wherein the first element and the second elements are group III elements and the third element is a group III or group V element, and wherein one or both of the first precursor solution and the second precursor solution comprises a group V precursor material.

In a sixty-seventh aspect, the disclosure provides a nanocrystal of the sixty-fifth or sixty-sixth aspect, wherein the reaction solution comprises a group V precursor material.

In a sixty-eighth aspect, the disclosure provides a nanocrystal of the sixty-fifth or sixty-seventh, wherein the first element is In, the second element and the third elements are both Ga, and the group V precursor material comprises P.

In a sixty-ninth aspect, the disclosure provides a layer comprising a matrix material and nanocrystals according to any of the thirty-eighth through sixty-first aspect dispersed therein.

In a seventieth aspect, the disclosure provides a layer of the sixty-ninth aspect, wherein the matrix comprises a silicone, a polymer or a glass.

In a seventy-first aspect, the disclosure provides a solid-state lighting or display device comprising the layer of the sixty-ninth through seventieth aspect.

1. A nanocrystal comprising a III-V class semiconductor core and a II-VI class semiconductor shell that at least partially coats the core, the shell comprising a magnesium-containing first zone and a magnesium-free buffer zone provided between the core and the first zone.

2. The nanocrystal of claim 1, wherein the first zone comprises ZnMgSe, ZnMgS, ZnMgSeS, CdMgSe, CdMgS, CdMgSeS or combinations thereof.

3. The nanocrystal of claim 1, wherein the buffer zone comprises ZnSe, ZnS, ZnSeS, CdSe, CdS, CdSeS or combinations thereof.

4. The nanocrystal of claim 1, wherein the core comprises a ternary or quaternary semiconductor material having a non-homogeneous distribution of components.

5. The nanocrystal of claim 1, wherein the core comprises Al, Ga or In, or combinations thereof.

6. The nanocrystal of claim 1, wherein the core comprises P, N, As, or Sb, or combinations thereof.

7. The nanocrystal of claim 1, wherein the shell fully coats the core.

8. A nanocrystal comprising a semiconductor core and a II-VI class semiconductor shell that at least partially coats the core, the shell including a magnesium-containing first zone proximal to the core, a second zone distal from the core, the second zone having less magnesium than the first zone and a magnesium-free buffer zone provided between the core and the first zone.

9. The nanocrystal of claim 8 wherein the first zone comprises ZnMgSe, ZnMgS, ZnMgSeS, CdMgSe, CdMgS, CdMgSeS or combinations thereof.

10. The nanocrystal of claim 8 wherein the second zone is substantially free of magnesium.

11. The nanocrystal of claim 8, wherein the second zone comprises ZnSe, ZnS, ZnSeS, CdSe, CdS, CdSeS or combinations thereof.

12. The nanocrystal of claim 8, wherein the buffer zone comprises ZnSe, ZnS, ZnSeS, CdSe, CdS, CdSeS or combinations thereof.

13. The nanocrystal of claim 8, wherein the core comprises a III-V class semiconductor material.

14. The nanocrystal of claim 8, wherein the core comprises ternary or quaternary semiconductor material having a non-homogeneous distribution of components.

15. The nanocrystal of claim 13, wherein the core comprises InP, GaP, AlP, InN, GaN, AN, InSb, GaSb, AlSb, InAs, GaAs, AlAs, or combinations, thereof.

16. The nanocrystal of claim 8, wherein the shell fully coats the core.

17. A nanocrystal comprising a ternary or quaternary III-V class semiconductor core and a II-VI class semiconductor shell that at least partially coats the core, the shell comprising ZnMgSe, ZnMgS, ZnMgSeS, CdMgSe, CdMgS, CdMgSeS or combinations thereof.

18. The nanocrystal of claim 17, wherein the core has a non-homogeneous distribution of components.

19. The nanocrystal of claims 17, wherein the core comprises InGaP, InAlP, GaAlP, InGaN, InAlN, GaAlN, InGaSb, InAlSb, GaAlSb, InGaAs, InAlAs, GaAlAs, or combinations thereof

20. The nanocrystal of claims 17, wherein the shell fully coats the core.
